(19) United States
(12) Patent Application Publication
(10) Pub. No.: US 2006/0053828 A1
(43) Pub. Date: Mar. 16, 2006

(54) Low temperature cooler

(76) Inventors: Richard W. Shallman, Richland, WA (US); Erik C. Shallman, Richland, WA (US)

Correspondence Address: Intellectual Property Department;DEWITT ROSS & STEVENS S.C., US Bank Building, 8000 Excelsior Drive, Suite 401, Madison, WI, 53717-1914, US

(21) Appl. No.: 10/941,128

(22) Filed: Sep. 15, 2004

(51) Int. Cl. F17C 9/02; F25C 1/00; F25D 3/12; F17C 13/00; F25B 21/00

(52) U.S. Cl. 62/457.9; 62/50.2; 62/385

(57) ABSTRACT

The invention is directed to a low-temperature cooler using dry ice as a cooling agent. The cooler has two compartments, one for the dry ice and one for chilled storage. The cooler self-regulates via an aqueous filled temperature-regulating valve to maintain a desired temperature in the storage compartment such that the products stored therein are stored at an optimum temperature. Upon achieving a predetermined temperature in the storage compartment, the valve closes, thereby maintaining the predetermined temperature in the storage compartment.

### FIELD OF THE INVENTION

The invention is generally directed to a portable cooler for storing and containing perishable items for transport. The invention is more specifically directed to a portable cooler comprising a first compartment for cooling and a second compartment for storage. A self-regulating valve acts to allow entry of cooling vapor from the coolant compartment into the storage compartment until a desired temperature in the storage compartment is reached.

### DESCRIPTION OF THE PRIOR ART

Portable coolers have become ubiquitous in modern culture. As personal transport has become commonplace in society, so too has society's desire to take their portable coolers, containing perishable products, with them. While some portable coolers are quite sophisticated and made of expensive material, others are very simple, disposable coolers made of inexpensive polymer foam or other insulated material. However, while the construction of portable coolers may vary greatly, the means of cooling items stored within them does not.

Most portable coolers are adapted to use ice as the cooling agent. In its most simplified form, a cooler has but one compartment containing both the ice and products to be cooled. When the cooling agent is ice, this arrangement can lead to waterlogged products, as well as a large volume of water when the ice melts. Alternatively, the cooling agent can be in a separate compartment from the products to be cooled. When ice is the cooling agent, the temperature of the products will not be maintained at about the freezing point of water (0° C.), as segregation of the ice from the stored products engenders higher temperatures in the storage compartment. Consequently, there exists a dilemma between maintaining the product at the lowest temperature and keeping the products dry.

There have been several efforts to solve these problems. For example, U.S. Pat. No. 4,577,475 to Herrera describes a portable cooler having multiple compartments wherein an upper compartment will hold ice, along with beverages and foodstuffs, while lower compartments can be used to hold other products as well. In the design taught by Herrera, the water from the melted ice drains either from a tap in the top compartment or a tap in the bottom compartment.

Other efforts to design coolers have resulted in portable refrigeration units such as those described in U.S. Pat. No. 3,585,813 to Hansen, U.S. Pat. No. 3,959,982 to Denis et al. and U.S. Pat. No. 5,555,740 to Stevenson, to name a few. The Hansen, Denis, and Stevenson patents describe the use of double-chambered coolers where one chamber is adapted to hold a liquid refrigerant while a series of coils passes through the walls of the second compartment, thereby maintaining a reduced temperature in the storage compartment.

Other attempts to maintain a maximally-reduced temperature in a portable cooler rely on frozen carbon dioxide or dry ice as the cooling agent. U.S. Pat. No. 2,610,472 to Maxwell describes a double-chambered cooler where one chamber is adapted to store dry ice and an adjacent chamber is a storage chamber for items to be chilled. The storage compartment is designed with one or more cooling coils running through the bottom so as to absorb heat from the storage compartment. The dry ice chamber is designed to have a grate or grill suspended above the floor of the chamber so that gas from the sublimation of the dry ice collects underneath the grate and is forced through the coils.

U.S. Pat. No. 3,820,355 to Olivares describes a three-chambered cooler. The first chamber comprises an insulated containment for dry ice. The second chamber comprises an empty or secondary “step-up” container sharing a common floor with the first chamber that is made of a suitable heat-transferring material. The third chamber comprises the storage chamber. The storage chamber also has a conduit or coil passing from the first chamber through the third chamber and vented to the outside.

U.S. Pat. No. 4,195,491 (the '491 patent”) and U.S. Pat. No. 4,288,996 (the '996 patent”) to Roncaglione describe some similar dry ice coolers. The '491 patent describes a conversion kit for traditional ice chest coolers. The kit comprises a small container that is placed in the middle of the cooler and a pair of refrigeration coils that are displaced on the front and back sides of the cooler. The coils are designed to vent to the outside through a side drainage opening. The '996 patent describes a dry ice cooler essentially as results from the conversion of the traditional cooler with the kit of the '491 patent.

U.S. Pat. No. 6,212,901 to Pint et al describes a dry ice cooler having two chambers and a two-piece lid. One smaller chamber is for dry ice while a second, larger storage chamber is for items to be cooled. The covers or lids for the cooler fit over each of the chambers such that the lid for the large chamber is larger than the lid for the smaller chamber. The lids each have a heat transfer element on their inner end such that when the lids are in the closed position, the heat transfer elements come together such that the heat from the large storage container is absorbed by the cooled element connected with the dry ice chamber. The temperature of the storage chamber is regulated by covering the element to a greater or lesser degree.

As may be appreciated, the use of portable coolers comprising liquid cooling units is neither economical nor disposable. The units described above, using dry ice as a coolant, are generally quite complicated and depend on cooling coils to transfer heat which also adds considerable expense to their manufacture. Moreover, there is generally very little ability to control the temperature, except for venting the collected gas to the outside or, as in Pint, covering the heat transfer element. However, as the activity in the field illustrates, there is an unmet need for an inexpensive yet efficient cooler that maintains low storage temperatures and does not result in melted ice and water-logged food products. In addition, the cooler should be portable and reusable but also disposable, if desired.

### SUMMARY OF THE INVENTION

It is therefore an object of the present invention to provide a portable, low-temperature cooler comprising an insulated container having a first chamber and a second chamber. The cooler will act to maintain the temperature in the storage compartment at a desired temperature, such as, for example, at about at least 0° C., and provide a method for self-regulating the temperature so as to maintain the temperature in the first chamber at the predetermined temperature.

In one preferred version of the invention, the cooler comprises an insulated container having a first chamber and a second chamber. The first chamber comprises a coolant chamber and contains a cooling agent, and the second chamber is a product storage compartment. The invention also includes a coolant tube leading from the first chamber to the second chamber. In addition, the coolant tube includes a temperature-regulating valve, the temperature-regulating valve controlling the entry of gaseous vapors produced by the cooling agent into the second chamber from the first chamber via the coolant tube.

In another preferred version, the cooler comprises an insulated container having a top, a bottom, opposing front and back sides and two opposing ends. The interior space of the cooler further comprises two chambers separated from each other by an internal wall. The first chamber comprises a coolant chamber and the second chamber a product storage compartment. In addition, the first chamber further includes a pressurization container for holding a cooling agent. The pressurization container has a top so that the cooling agent inside the pressurization container remains enclosed. Inside the pressurization container is also a vapor space. A coolant tube, having a lumen and leading from the vapor space of the pressurization container to the product storage compartment, is also included. The coolant tube allows vapors from the cooling agent to enter the product storage compartment from the pressurization container. Further, the coolant tube includes a temperature-regulating valve, the temperature-regulating valve situated inside the product storage compartment. The temperature-regulating valve occludes the lumen of the coolant tube at a predetermined temperature and thereby stops the flow of vapor from the cooling agent. An exit-relief valve is also used to facilitate the flow of the vapor from the product storage compartment.

The advantages of the invention are several. First, the invention allows the temperature of the storage compartment to be kept at a specific temperature. Second, the invention allows the product in the storage compartment to be separated from the cooling agent so as not to be immersed in it. Third, the invention allows much colder temperatures to be achieved in the storage compartment than is currently possible with most disposable coolers. Fourth, the cooler is much more economically constructed than other cooling units achieving similar temperatures.

The cooler of the present invention can be used at multiple temperatures. For example, the cooler provides a container which can be used to ship perishable goods at about a temperature of 0° C., thereby keeping the produce fresh but unfrozen. The invention also allows the maintenance of colder temperatures in the storage compartment by changing the set point of the temperature-regulating valve and by changing the cooling agent. By manipulating these two variables, the temperature of the storage compartment can be maintained at, at least, about −80° C.

The objects and advantages of the invention will appear more fully from the following detailed description of the preferred embodiment of the invention made in conjunction with the accompanying drawings.

### BRIEF DESCRIPTION OF THE DRAWINGS

FIG. 1 is a perspective view of the cooler with the top open and the interior revealed.

FIG. 2 is a front section view of the cooler of the present invention taken along lines 2-2 of FIG. 1.

FIG. 3 is a perspective view of one embodiment of the valve of the present invention.

FIG. 4 is a perspective view of another embodiment of the valve of the present invention.

### DETAILED DESCRIPTION OF THE INVENTION

The invention is directed to a low-temperature, portable ice chest or cooler 10. The cooler 10 uses cooling agents 12 with a lower temperature than conventional ice, thereby allowing the temperature of products 14 stored in the cooler 10 to be maintained at temperatures approximating the temperature of the cooling agent 12. This allows the cooler 10 to be essentially self-regulating at that temperature.

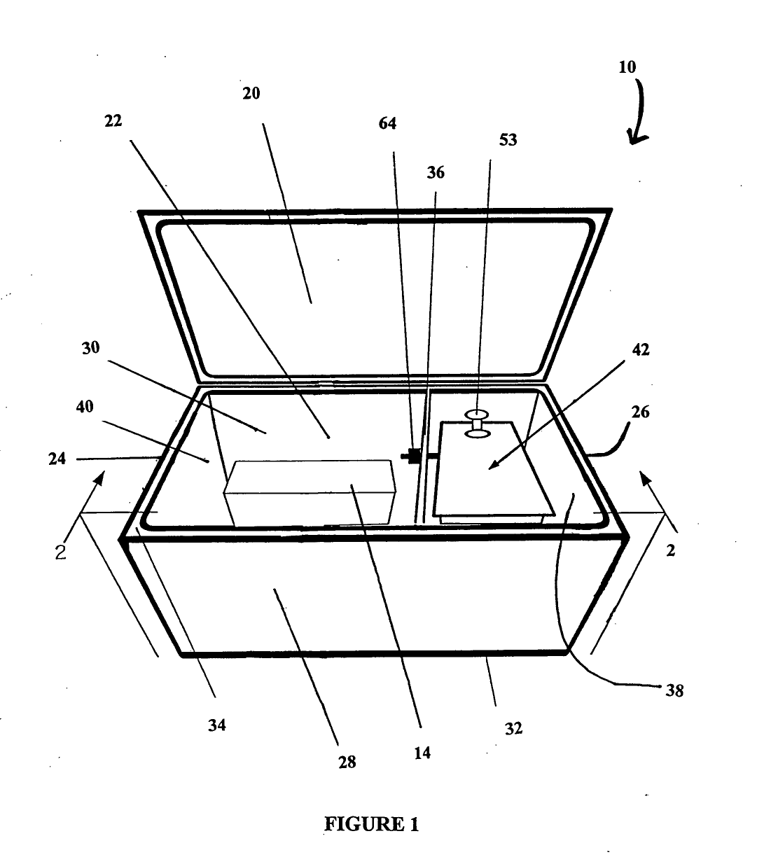

Referring now to FIG. 1, the cooler 10 is shown with its top 20 open, revealing the interior 22 of the cooler 10. The cooler 10 is formed from two opposing sides 24 and 26, a front side 28, a rear side 30 and a bottom 32. The sides 24, 26, 28 and 30 have an upper edge 34 on which the top 20 securely rests. While in some versions the top 20 may be removable, in other versions the top 20 has hinges (not shown) which attach the top 20 directly to the rear 30 of the cooler 10. When the top 20 is hingedly attached to the cooler 10, the top 20 can be secured by a latch or other fastener (not shown). When the top 20 is removable, the top 20 fits securely into the openings formed by the upper edges 34 of the sides 24, 26, 28 and 30. Further, the top 20 of the cooler 10 may comprise a two-part article having a separate cover for the storage compartment 40 and the coolant chamber 38. However, it is within the scope of the invention that the top 20 may be a single unit such that removing the top 20 exposes both the storage compartment 40 and coolant chamber 38.

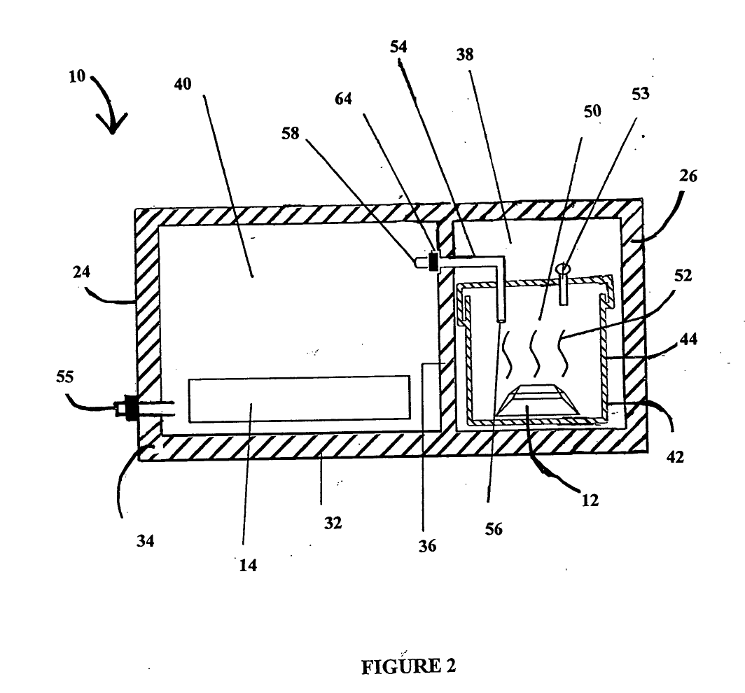

FIG. 1 also shows the internal wall 36 which divides the interior 22 of the cooler 10 into a coolant chamber 38 and a storage compartment 40 for products 14 to be cooled. The internal wall 36 can be of various thicknesses, depending on the products 14 stored and the cooling agents 12 (shown in FIG. 2) used. Further, the cooler 10 can be formed as a unitary article such that the internal wall 36 is an integral part of the cooler 10. It is also an aspect of the invention that the cooler 10 can be assembled with the internal wall 36 being added after the cooler 10 is fabricated.

The cooler 10 can be made of any insulated material. For example, more permanent coolers 10 may be made from durable polymers and metal alloys while less expensive coolers 10 may be made of disposable foam polymers, cardboard or other inexpensive materials.

Referring to both FIGS. 1 and 2, the coolant chamber 38 of the cooler 10 includes a pressurization container 42. The cooling agent 12 is contained within the pressurization container 42. The pressurization container 42 comprises a closed container suitable for containing a low-temperature cooling agent 12. The pressurization container 42 is configured to fit within the coolant chamber 38. The pressurization container 42 has walls 44, a bottom and a removable top (not shown). The pressurization container 42 is further configured to be air-tight when the top is secured in place. In some versions, the pressurization container 42 may be square while in other versions the pressurization container 42 is rectangular. In some versions, the top of the pressurization container 42 fits snugly into corresponding grooves (not shown) formed by the walls 44 of the pressurization container 42. In other versions, the pressurization container 42 is cylindrical and the top may be attached to the pressurization container 42 via a threaded neck (not shown).

The pressurization container 42 also includes a vapor space 50. The vapor space 50 collects vapor 52 released from a cooling agent 12. The vapor 52 released from the cooling agent 12 collects in the vapor space 50 and is maintained under pressure due to the air-tight design of the pressurization container 42. In some preferred versions, the pressurization container 42 is fabricated of an insulating material such as foam, insulated metal or insulated glass.

Also illustrated in FIG. 2 is a coolant tube 54. The coolant tube 54 is hollow and has a first end 56 and a second end 58. The first end 56 originates in the pressurization container 42 of the coolant chamber 38. The coolant tube 54 passes through an opening in the top of the pressurization container 42 and through an opening in the internal wall 36, where the second end 58 of the coolant tube 54 terminates in the storage compartment 40.

An aqueous filled temperature-regulating valve 64 is fitted around the circumference of the coolant tube 54 after it enters the storage compartment 40. By using a cooling agent 12 that vaporizes, the vapor 52 collecting in the vapor space 50 of the pressurization container 42 is forced into the first end 56 of the coolant tube 54 and passes through the coolant tube 54 into the storage compartment 40 via the second end 58 of the coolant tube 54.

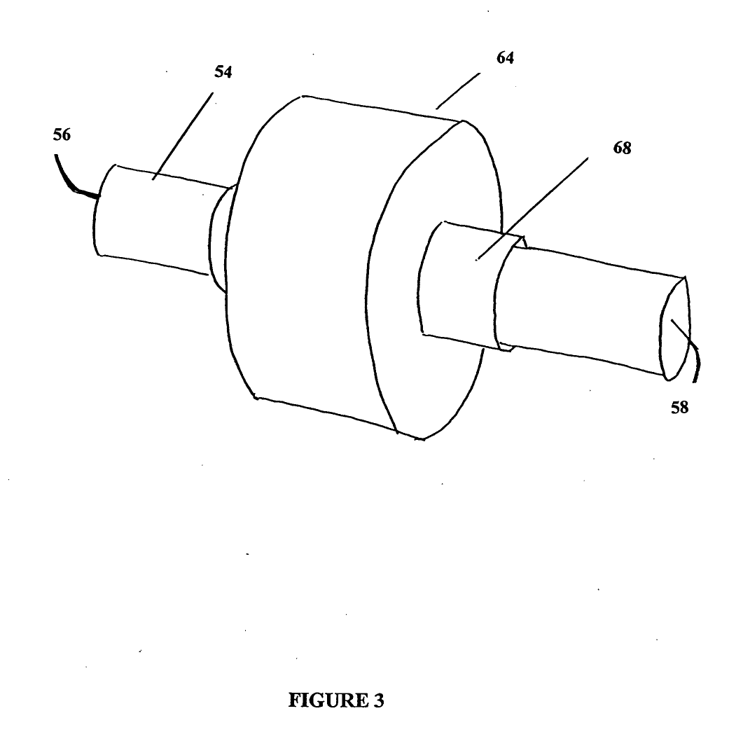

Illustrated in FIG. 3, the temperature-regulating valve 64 is designed to regulate the amount of cooling vapor 52 entering the storage compartment 40 and thereby maintain the temperature in the storage compartment 40 at a desired level. The donut-shaped temperature-regulating valve 64 contains a fluid (not shown), which, upon freezing, expands. When expanded, the fluid closes the coolant tube 54 by occluding the lumen 68. By closing the coolant tube 54, vapor 52 from the cooling agent 12 is prevented from entering the storage compartment 40, thereby allowing the temperature in the storage compartment 40 to rise. The freezing point of the fluid in the temperature-regulating valve 64 determines the temperature set point of the storage compartment 40 in which the temperature-regulating valve 64 is situated. For example, when the fluid in the temperature-regulating valve 64 is pure water, the set point is 0° C., the freezing point of water. When the fluid in the temperature-regulating valve 64 is water plus a solute, the freezing point of the solution is depressed according to the concentration of the solute used to prepare the fluid. In some instances, the outer surface of the temperature-regulating valve 64 will be covered with a thin layer of insulating material (not shown) such as foam or rubber, thereby allowing the fluid in the temperature-regulating valve 64 to equilibrate with the ambient temperature of the storage compartment 40 rather than allowing the temperature-regulating valve 64 to become super-cooled by direct contact with the coolant tube 54.

In instances where different temperatures are desired in the storage compartment 40, the temperature at which the temperature-regulating valve 64 closes can be varied. For example, the set point of the temperature-regulating valve 64 can be altered by adding solutes to the fluid contained in the temperature-regulating valve 64, thereby decreasing the temperature at which the temperature-regulating valve 64 closes. For example, while dry ice has a melting point of −78° C., liquid nitrogen has a boiling point of −195.8° C. The freezing point of a liquid may be lowered by adding a solute to the fluid in accord with the equation for freezing point depression:
T=iK_{f}m
where the change in the melting point (T) is a function of: i (the van't Hoff factor, the number of particles into which the solute dissociates); m (the molality of solute in the liquid); and K_{f} (the freezing point constant for the liquid). By making use of the solute effect on the freezing point, the set-point of the temperature-regulating valve 64 can be lowered from 0° C. This method for depressing the freezing point of a liquid is routinely practiced by automobile owners when using a mixture of antifreeze and water in their cars' cooling systems.

Also illustrated in FIGS. 1 and 2 is a pressure-release valve 53. As the cooling agent 12 produces vapor 52, the vapor 52 increases the pressure within the pressurization container 42. Including a pressure-release valve 53 in the pressurization container 42 prevents the vapor 52 from creating unnecessarily or dangerously high pressure levels. The pressure-release valve 53 is inserted into the vapor space 50 of the pressurization container 42. The pressure-release valve 53 can be inserted through the walls 44 or the top of the pressurization container 42. In some versions of the invention, the pressure-release valve 53 vents excess vapor 52 from the pressurization container 42 into the coolant chamber 38 of the cooler 10. In other versions of the invention, the pressure-release valve 53 vents excess vapor 52 to the outside environment. When the pressure-release valve 53 vents to the outside, it may enter through the walls 44 of the pressurization container 42.

In addition, by situating the pressure-release valve 53 in the vapor space 50, the force of the vapor 52 entering the coolant tube 54 can be regulated. Regulating the force of the vapor 52 allows the pressure-release valve 53 to serve as an auxiliary temperature control. By lowering the tolerance of the pressure-release valve 53, increased vapor 52 is drawn off of the vapor space 50. This lowers the force of the vapor 52 as it passes into the storage compartment 40 and allows the temperature in the storage compartment 40 to increase. By increasing the tolerance of the pressure-release valve 53, less vapor 52 is drawn off of the vapor space 50, thereby increasing the force of the vapor 52 entering the coolant tube 54. As will be apparent to those of skill in the art, the temperature resulting in the storage compartment 40 is a function of the overall force of the vapor 52 as it enters the storage compartment 40. The force of the vapor 52 is determined by the pressure of the vapor 52 produced and the resistance provided by the pressure-release valve 53. Pressure-release valves 53 similar to those described are commercially available as both preset valves and as adjustable valves from Cole-Palmer Instrument Co., Vernon Hills, Ill., and Aldrich Chemicals, Milwaukee, Wis.

The cooler 10 of the present invention may also contain an exit-relief valve 55, as shown in FIG. 2. The exit-relief valve 55 may be located on the opposing side of the storage compartment 40 from the temperature-regulating valve 64. The exit-relief valve 55 facilitates the flow of the cooling vapor 52 as it exits the storage compartment 40. The exit-relief valve 55 may be positioned through the wall 24 of the cooler 10. The exit-relief valve 55 must be set at a lower level than the pressure release valve 53 to allow the cooling vapor 52 to flow throughout the product storage chamber 40.

Referring again to FIG. 3, a first embodiment of the temperature-regulating valve 64 can be seen. In this embodiment, the temperature-regulating valve 64, referred to as a “Donut” valve, comprises an insulation layer 68 around the coolant tube 54 to prevent conduction from prematurely freezing the temperature-regulating valve 64. The temperature-regulating valve 64 surrounds the coolant tube 54 and may be encased in a flexible membrane, such as plastic (not shown). In this embodiment, the temperature-regulating valve 64 contains a fluid and acts as a membrane through which the vapor 52 passes. As discussed previously, the fluid can be water. As the fluid in the “donut” temperature-regulating valve 64 freezes, it compresses the coolant tube 54 and discontinues the flow of the coolant 12 from the coolant chamber 38 to the storage compartment 40 via the opening in the internal wall 36.

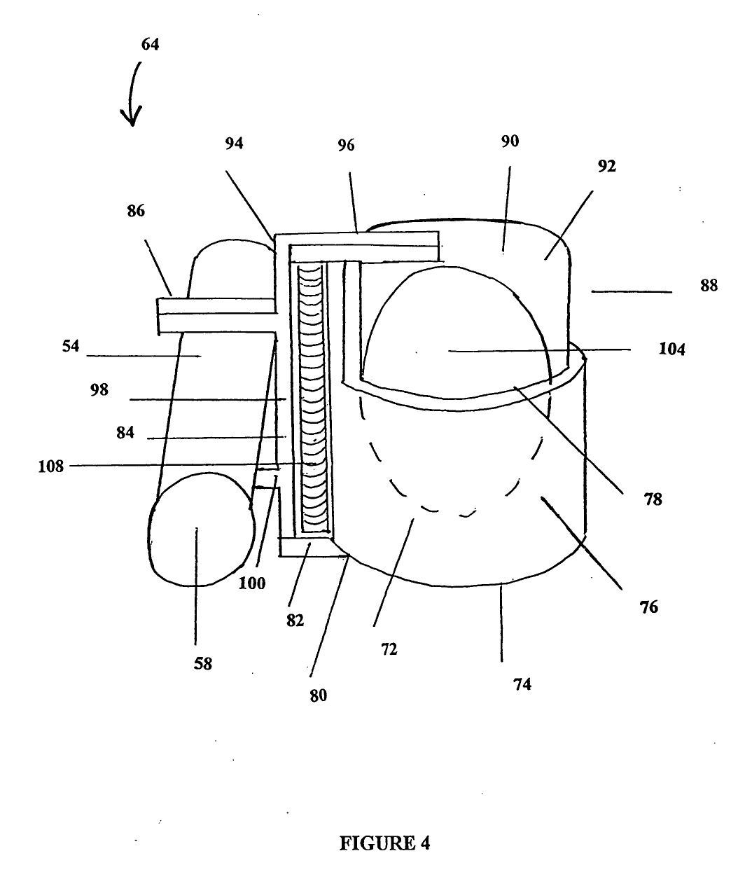

Referring now to FIG. 4, a second embodiment of the temperature-regulating valve 64 is shown. In this embodiment, the temperature-regulating valve 64, in the form of a “Pincer” valve, comprises a base cylinder 72. The base cylinder 72 includes a first closed end 74, sides 76 and a second open end 78. Attached to the first closed end 74 is the first pincer 80, which includes a base arm 82, an extension arm 84 and a cross arm 86.

The temperature-regulating valve 64 also includes a nested sliding cylinder 88. The sliding cylinder 88 includes a first closed end 90, sides 92 and a second open end (not shown). The sliding cylinder 88 is designed to be slidably nested with the open end 78 of the base cylinder 72. Attached to the first closed end 90 of the nested sliding cylinder 88 is a second pincer 94, which also includes a base arm 96, an extension arm 98 and cross arms 100. Within the base cylinder 72 and sliding cylinder 88 is a membrane-filled expansion fluid sac 104, filled with fluid. The cross arms 100 are crossed such that when the base cylinder 72 and the sliding cylinder 88 expand, the arms 100 come together to pinch the coolant tube 54 shut. This design incorporates a spring 108 connected to the pincers 80 and 94 that opens the pincers 80 and 94, thereby allowing fluid to flow through the coolant tube 54. When the pincers 80 and 94 move together, the spring 108 is stretched. When the fluid in the sac 104 melts, the spring 108 pulls the pincers 80 and 94 open, resetting the cylinders 72 and 88 and allowing fluid to flow through the coolant tube 54.

Different uses for the cooler 10 may require different set points for the temperature of the storage compartment 40. For example, if the cooler 10 is used for transporting fresh produce, it would be desirable to keep the temperature in the storage compartment 40 close to 0° C. so as to keep the products 14 in the storage compartment 40 unspoiled but also unfrozen. In this instance, the fluid in the temperature-regulating valve 64 would be pure water and the pressurization container 42 would contain dry ice so as to rapidly chill the storage compartment 40 while maintaining the temperature of the storage compartment 40 above freezing. However, if the stored products 14 were biological samples, it would be desirable to keep them very cold. Typically, biological samples such as reagents, cells or tissues are shipped packed in dry ice. However, by using the current invention, the temperature in the storage compartment 40 could be maintained at the desired temperature by using dry ice as the cooling agent 12 and a water-solute mixture for the fluid in the temperature-regulating valve 64. Therefore, temperatures in the storage compartment 40 can be set lower than 0° C. In addition, while other cooling agents 12, such as liquid nitrogen, may be used, dry ice is the safest and most easily available sub-zero cooling agent 12.

It will be appreciated by those of skill in the art that there are alternative configurations to the temperature-regulating valve 64. All that is necessary is a configuration that harnesses the energy derived from the expanding fluid contained within the temperature-regulating valve 64. For example, the temperature-regulating valve 64 may comprise a “donut” fitting on the inside of the coolant tube 54, whereby the temperature-regulating valve 64 expands, thereby occluding the lumen 68 of the coolant tube 54. In another preferred version (not shown), the temperature-regulating valve 64 includes a large marble-shaped, aqueous-filled sphere made of a distensible material such as rubber, latex, silicone or other material. In this version, the distensible sphere sits inside a tube and is held in place by internal radial rabbets. Upon freezing and expansion of the sphere, the sphere seats firmly against the grooves of the walls of the pressurization container 42, thereby occluding the lumen 68 and stopping the flow of vapor 52 into the storage compartment 40.

It is understood that the invention is not confined to the particular construction and arrangement of parts herein illustrated and described but embraces such modified forms thereof as come within the scope of the following claims.

What is claimed is:

1. A low-temperature cooler comprising:
a. an insulated container having a first compartment and a second compartment, wherein the first compartment contains a cooling agent and the second compartment is a product storage compartment;
b. a coolant tube leading from the first compartment to the second compartment, wherein the coolant tube further includes a temperature-regulating valve;
whereby the temperature of the second compartment is cooled by gaseous vapors of the cooling agent entering the second compartment from the first compartment via the coolant tube.

2. The cooler of claim 1, wherein the first compartment further includes a pressurization container for containing the cooling agent.

3. The cooler of claim 2, wherein the pressurization container further comprises a vapor space.

4. The cooler of claim 3, wherein the coolant tube leads from the vapor space to the product storage compartment.

5. The cooler of claim 2, wherein the first compartment includes a pressure-release valve, the pressure-release valve leading from the first compartment to the environment outside the pressurization container.

6. The cooler of claim 5, wherein the pressure-release valve leads from the pressurization container to the environment outside the cooler.

7. The cooler of claim 1, wherein the temperature-regulating valve contains a fluid which occludes the coolant tube upon reaching a predetermined temperature.

8. The cooler of claim 7, wherein the fluid solution in the temperature-regulating valve is water.

9. The cooler of claim 1, wherein the cooling agent is selected from the group consisting of ice, dry ice, liquid nitrogen and combinations thereof.

10. The cooler of claim 1, comprising an insulated internal wall dividing the first compartment from the second compartment.

11. The cooler of claim 1, wherein the cooler has a two-part top such that one compartment can be opened without opening the other compartment.

12. The cooler of claim 1, wherein the first compartment has a floating cover fabricated out of an insulating material and the cooler has a unitary top.

13. A low temperature cooler comprising:
a. an insulated container having a top, a bottom, opposing front and back sides and two opposing ends;
b. an interior space comprising a first coolant chamber and a second product storage compartment, wherein the coolant chamber and the product storage compartment are separated from each other by an internal wall;
c. a pressurization container defined within the first compartment for holding a cooling agent and vapor space, the pressurization container having a top such that the cooling agent situated inside is enclosed by the top;
d. a coolant tube having a lumen and leading from the vapor space of the pressurization container to the product storage compartment, whereby vapors enter the product storage compartment from the pressurization container; and
e. a temperature-regulating valve defined on the coolant tube,
wherein the temperature-regulating valve is situated inside the product storage compartment.

14. The cooler of claim 13, wherein the temperature-regulating valve contains a fluid, wherein freezing the fluid occludes the lumen.

15. The cooler of claim 13, wherein the fluid in the temperature-regulating valve is selected from the group consisting of water or solutions thereof.

16. The cooler of claim 13, wherein the cooling agent is selected from the group consisting of ice, dry ice, liquid nitrogen and combinations thereof.

17. The cooler of claim 13, wherein the pressurization container further comprises a pressure-release valve, the pressure-release valve dimensioned and configured to lead from the vapor space to the environment outside the cooler.

18. The cooler of claim 13, which is fabricated from polymer foam, cardboard, plastic, cellulose fibers and combinations thereof.
